(19) United States
(12) Patent Application Publication
(10) Pub. No.: US 2026/0184315 A1
(43) Pub. Date: Jul. 2, 2026

(54) CONTROL METHOD FOR A 2-SPEED AWD VEHICLE

(71) Applicant: HYUNDAI WIA Corporation, Changwon-si (KR)

(72) Inventors: Pu Reun Lee, Uiwang-si (KR); Seon Jae Kim, Uiwang-si (KR)

(73) Assignee: HYUNDAI WIA Corporation, Changwon-si, GG (KR)

(21) Appl. No.: 19/425,861

(22) Filed: Dec. 18, 2025

(30) Foreign Application Priority Data
Dec. 31, 2024 (KR) 10-2024-0202478

(51) Int. Cl. B60W 30/188; B60W 30/045; B60W 30/18

(52) U.S. Cl. CPC B60W 30/188; B60W 30/045; B60W 30/18009; B60W 2510/1005; B60W 2520/105; B60W 2520/125; B60W 2520/14; B60W 2520/26; B60W 2520/28; B60W 2540/18

(57) ABSTRACT

Disclosed is a method of controlling a two-speed AWD vehicle. According to the present embodiment, control may be performed on an electric vehicle by outputting AND control torque to a propeller shaft by means of detailed torque control in a 4H or 4L mode.

### CROSS-REFERENCE TO RELATED APPLICATION

The present application claims priority to Korean Patent Application No. 10-2024-0202478, filed on Dec. 31, 2024, the entire contents of which are incorporated herein for all purposes by this reference.

### BACKGROUND OF THE DISCLOSURE

### Field of the Disclosure

The present disclosure relates to a method of controlling a two-speed AWD vehicle that aims to allow the two-speed AND vehicle to travel in an optimized state.

### Description of the Related Art

Electronic all-wheel drive (electronic AWD) is a system that distributes driving power for a vehicle to front and rear wheels by means of an electronic control unit, and the electronic AWD controls the driving power by using a sensor and an electric motor instead of mechanical connection.

The electronic AWD collects data in real time by detecting a speed of a vehicle, a rotational speed of a wheel, a steering angle of a steering handle, an accelerator pedal input, a road condition, and the like.

Further, the electronic control unit (ECU) calculates an optimal driving power distribution based on the collected data. As necessary, the electronic control unit distributes the driving power to the front and rear wheels or to front left and right wheels and rear left and right wheels.

In order to achieve the above-mentioned operation, the vehicle is equipped with an electric clutch or motor, and the electronic clutch transmits the power to the wheels or cuts off the transmission of power. In addition, a hybrid AWD system operates specific wheels by using an electric motor.

The electronic AWD improves fuel efficiency by operating only the front wheels at ordinary times in terms of efficiency. As necessary, the electronic AWD may quickly switch to four-wheel drive, such that the driving power is immediately adjusted at a high reaction speed in accordance with a change in road situation, thereby preventing slipping.

Because the electronic AWD may be structurally simplified and require fewer components than the traditional mechanical AWD, the electronic AWD enables weight reduction.

The electronic AWD may variously adjust a power distribution ratio between a main driving shaft and an auxiliary driving shaft based on a traveling state.

For example, in a front-wheel-drive vehicle (2WD), 100% of power is distributed to the front wheels, and 0% is distributed to the rear wheels. Further, the electronic AWD enables the distribution of power to the front wheels in various ratios. This means that a maximum of 50% of the power is distributed to the front wheels, and 50% of the power is distributed to the rear wheels.

General passenger vehicles are driven in a 4A mode (four-wheel auto mode) that actively and autonomously adjusts torque amount of the front and rear wheels in accordance with the traveling state.

However, off-road specialized vehicles, such as large-scale SUVs, additionally provide a 4H mode (4WD high gear mode) and a 4L mode (4WD low gear mode) by means of a switch operation, thereby providing a function of directly connecting a shaft with maximum torque.

When the 4H/4L mode is activated, the off-road specialized vehicle does not achieve an optimized control state that adopts all of various traveling states of the vehicle, which causes a phenomenon in which driving power is simply transmitted to a propeller shaft with a maximum torque amount.

In this case, excessive torque may be transmitted to the propeller shaft and a drive system, which may affect durability and increase consumption power to be consumed. Therefore, there is a need for countermeasures.

### DOCUMENT OF RELATED ART

(Patent Document 1) Korean Patent No. 10-2440674 (Sep. 1, 2022)

### SUMMARY OF THE DISCLOSURE

The present disclosure is proposed to solve these problems and aims to provide a method of controlling a two-speed AWD vehicle, the method being capable of controlling a minimum torque amount required to directly connect a propeller shaft in an optimal state in a 4H or 4L mode of the two-speed AWD vehicle.

A method of controlling a two-speed AWD vehicle according to one embodiment of the present disclosure includes: a first step ST100 of selecting any one of a 4H mode or a 4L mode and allowing a two-speed AWD vehicle to travel; and a second step ST200 of performing control to output AWD control torque, which is transmitted to a propeller shaft, as a minimum torque value in accordance with the mode selected from the 4H mode or the 4L mode.

The second step ST200 further includes: a traction control step ST210 of calculating traction total torque to output a maximum value (Max) for torque control in accordance with various traveling situations of the two-speed AWD vehicle; a TCB control step ST220 of controlling torque generated when the two-speed AWD vehicle is under a low-speed, high-steering traveling condition; and a handling control step ST230 of calculating handling control torque based on a traveling mode corresponding to turning characteristics of the two-speed AWD vehicle.

In the traction control step ST210, different gain values are applied based on shift positions of the two-speed AWD vehicle.

In the traction control step ST210, a minimum torque value (β) is applied to the gain value of the two-speed AND vehicle, and the maximum value (Max) is selected from calculated result torque values.

In the second step ST200, the torque value calculated in the TCB control step ST220 is applied to the maximum value (Max) and calculated, a minimum value (Min) is selected from calculated result values, and AWD control torque is calculated by calculating the minimum value (Min) and a handling torque value, which is outputted in the handling control step ST230, together.

The traction control step ST210 further includes: a basic anticipative torque control step ST211 of correcting a load distribution ratio by imparting a weight value to ensure performance according to the shift position and the traveling mode; a rolling prevention torque control step ST212 of classifying levels in accordance with an uphill traveling state and an inclination angle of a slope road when the two-speed AWD vehicle travels uphill or downhill; a start assistance torque control step ST213 of preventing a wheel slip when the two-speed AWD vehicle starts; and a low-shift-position shifting torque control step ST214 of performing control to output low-shift-position shifting torque for each gear shift position when the two-speed AWD vehicle shifts to a low shift position.

In the rolling prevention torque control step ST212, the uphill traveling state is determined by using a longitudinal acceleration, a lateral acceleration, a wheel speed, a steering angle, an accelerator opening degree, and braking pressure information.

In the start assistance torque control step ST213, a vehicle speed criterion and a torque control value are differently set in accordance with the traveling mode of the two-speed AWD vehicle.

In the start assistance torque control step ST213, a torque control amount for each gear shift position is classified in accordance with the accelerator opening degree of the two-speed AND vehicle, and a start assistance torque output is based on a speed of the two-speed AWD vehicle.

In the low-shift-position shifting torque control step ST214, an entry time point is controlled in a non-braking or non-acceleration state in which a target gear shift position is lower than a current gear shift position.

The TCB control step ST220 is determined based on the traveling mode of the two-speed AWD vehicle, longitudinal acceleration information, lateral acceleration information, wheel speed information, and a vehicle speed.

In the handling control step ST230, turning torque is calculated in accordance with a turning weight value according to a lateral acceleration, a yaw rate, and a steering angle according to turning characteristics of the two-speed AWD vehicle.

4H or 4L mode of the two-speed AWD vehicle is classified into: a P-shift position stop mode in which the two-speed AWD vehicle switches to 2WD in a P-shift position stop state; a D/R/N-shift position stop mode for controlling traveling of a driver when the two-speed AWD vehicle is in a D-shift position state, an R-shift position state, or an N-shift position state; a gear shifting standby mode for restricting torque occurring when the two-speed AND vehicle suddenly shifts from a low shift position to a high shift position or from the high shift position to the low shift position; a low-speed optimized traveling mode in which a minimum torque value is outputted to the propeller shaft in a 4A mode of the two-speed AWD vehicle; and a high-speed optimized traveling mode in which a maximum torque value is outputted to the propeller shaft in the 4A mode of the two-speed AWD vehicle.

### BRIEF DESCRIPTION OF THE DRAWINGS

FIG. 1 is a flowchart illustrating a method of controlling a two-speed AWD vehicle according to the present embodiment.

FIG. 2 is a flowchart illustrating a detailed configuration of a traction control step in the method of controlling a two-speed AWD vehicle according to the present embodiment.

FIG. 3 is a view illustrating detailed configurations of 4H and 4L modes in the method of controlling a two-speed AWD vehicle according to the present embodiment.

FIG. 4 is a view briefly illustrating a process of calculating AWD control torque by a second step in the method of controlling a two-speed AWD vehicle according to the present embodiment.

### DETAILED DESCRIPTION OF THE DISCLOSURE

Advantages and features of the present disclosure and methods of achieving the advantages and features will be clear with reference to exemplary embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art to which the present disclosure pertains can fully understand the scope of the present disclosure. The present disclosure will be defined only by the scope of the appended claims. Throughout the specification, the same reference numerals denote the same constituent elements.

A configuration in which one constituent element is “connected to” or “coupled to” another constituent element includes both a configuration in which one constituent element is connected or coupled directly to another constituent element and a configuration in which another constituent element is interposed therebetween. In contrast, when one constituent element is “connected directly to” or “coupled directly to” another constituent element, there are no constituent elements interposed therebetween. The term “and/or” includes each and all combinations of one or more of the mentioned items.

The terms used in the present specification are for explaining the embodiments, not for limiting the present disclosure. Unless particularly stated otherwise in the present specification, a singular form also includes a plural form. The terms “comprise (include)” and/or “comprising (including)” used in the specification are intended to specify the presence of the mentioned constituent elements, steps, operations, and/or elements, but do not exclude the presence or addition of one or more other constituent elements, steps, operations, and/or elements.

The terms “first”, “second”, and the like may be used to describe various components, but the components are of course not limited by these terms. These terms are merely used to distinguish one component from another component.

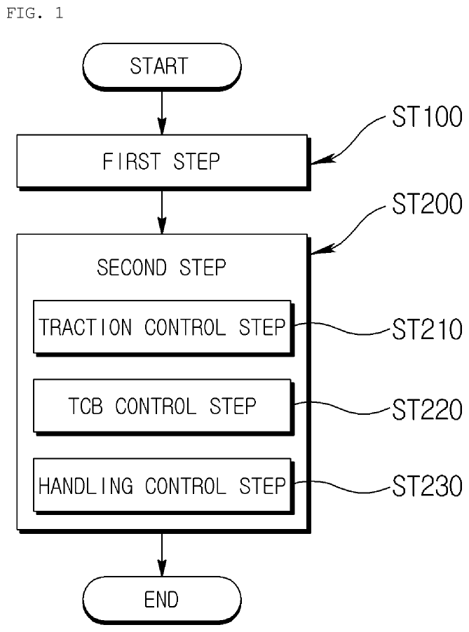

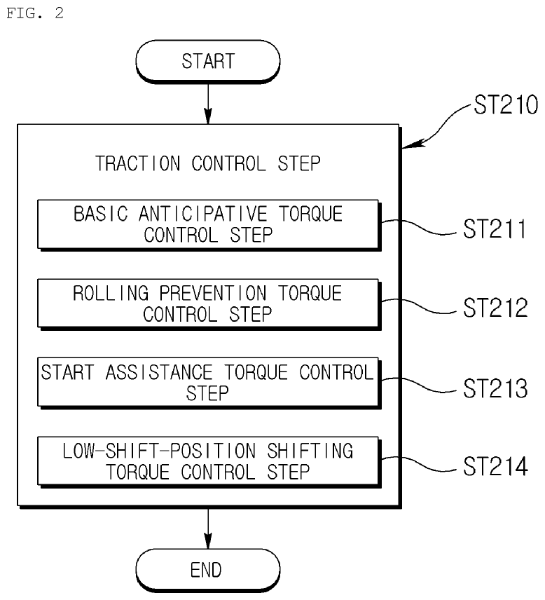

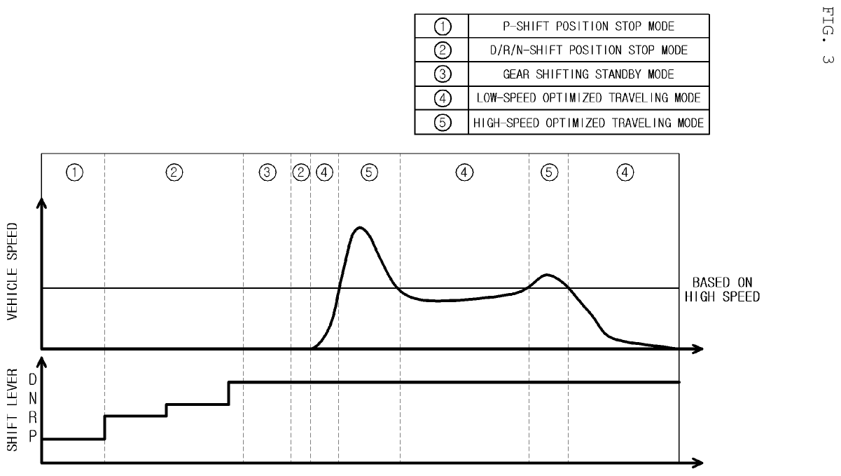

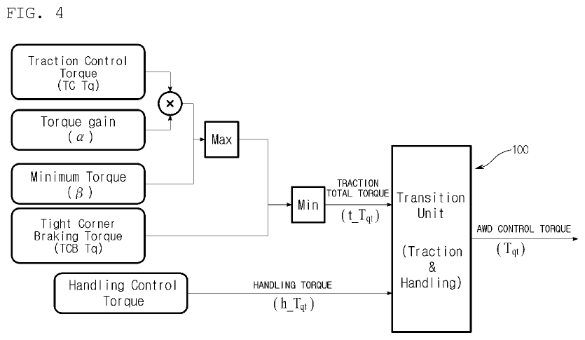

A method of controlling a two-speed AWD vehicle according to the present embodiment will be described with reference to the drawings. For reference, FIG. 1 is a flowchart illustrating a method of controlling a two-speed AWD vehicle according to the present embodiment, FIG. 2 is a flowchart illustrating a detailed configuration of a traction control step in the method of controlling a two-speed AND vehicle according to the present embodiment, FIG. 3 is a view illustrating detailed configurations of 4H and 4L modes in the method of controlling a two-speed AWD vehicle according to the present embodiment, and FIG. 4 is a view briefly illustrating a process of calculating AWD control torque by a second step in the method of controlling a two-speed AWD vehicle according to the present embodiment.

With reference to FIGS. 1 to 4 attached hereto, the method of controlling a two-speed AWD vehicle according to the present embodiment includes a first step ST100 of selecting any one of a 4H mode or a 4L mode and allowing the two-speed AWD vehicle to travel, and a second step ST200 of performing control to output AWD control torque, which is transmitted to a propeller shaft, as a minimum torque value in accordance with the mode selected from the 4H mode or the 4L mode.

In particular, the present embodiment segmentalizes the mode into five types of modes (a P-shift position stop mode, a D/R/N-shift position stop mode, a shifting standby mode, a low-speed optimized traveling mode 4L, and a high-speed optimized traveling mode 4H) in case that the two-speed AWD vehicle switches to the 4H or 4L mode. Further, based on the segmentalized five types of modes, AND control torque (Tqt), which is transmitted to the propeller shaft in the 4H or 4L mode, may be controlled to be outputted as the minimum torque value.

In this case, stable vehicle traveling may be achieved when a large driving force is required for mild off-road escape or towing, or when passing through a rough section.

In the first step ST100 according to the present embodiment, the two-speed AWD vehicle may travel in any one mode selected from the 4H mode or the 4L mode.

The 4H mode is a 4WD high gear mode and is used when the two-speed AWD vehicle travels on unpaved roads, low-traction surfaces, or slippery roads, such as winter snow-covered roads, where the vehicle two-speed AWD is at risk of losing traction. In the 4H mode, all wheels of the two-speed AWD vehicle need to be driven.

The 4L mode is a 4WD low gear mode and is used when the two-speed AWD vehicle travels on a completely off-road path requiring strong traction on all wheels of the two-speed AWD vehicle, particularly when the two-speed AWD vehicle needs to operate at speeds of 20 km/h or below. However, the above-mentioned road or surface conditions are not limited thereto and may be variously changed.

The second step ST200 according to the present embodiment further includes a traction control step ST210 of calculating traction total torque (TC_Tq) to output a maximum (Max) value for torque control in accordance with various traveling situations of the two-speed AWD vehicle, a TCB control step ST220 of controlling torque (TCB_Tq) generated when the two-speed AWD vehicle is under a low-speed, high-steering traveling condition, and a handling control step ST230 of calculating handling control torque (h_Tqt) based on a traveling mode corresponding to turning characteristics of the two-speed AWD vehicle. For reference, the TCB is defined as tight corner braking (TCB).

The traction control step ST210 is provided to improve traction performance by means of anticipative torque control in accordance with various traveling situations of the two-speed AWD vehicle, and the torque value is continuously calculated and outputted simultaneously.

In the present embodiment, different gain (x) values are applied to the output value calculated in the traction control step ST210 based on shift positions of the two-speed AWD vehicle, and the gain value (x) decreases when the two-speed AWD vehicle shifts from a low shift position to a high shift position.

For example, the gain value may be a gain value (α) of 1 at the first and second shift position, and the gain value may be a gain value (α) smaller than 1 at the third shift position. However, the specific numerical value may vary depending on setting values.

In the traction control step ST210, a minimum torque value (β) is applied to the gain value (α) of the two-speed AND vehicle, and the maximum value (Max) is selected from calculated result torque values.

The minimum torque value (β) according to the present embodiment has a torque value that varies depending on the above-mentioned five types of modes. The reason why the maximum value (Max) is selected is that relatively high torque is required for low-speed traveling of the two-speed AWD vehicle, when the 4H or 4L mode is selected, compared to high-speed traveling of the two-speed AWD vehicle. Therefore, the maximum value (Max) is selected, as described above.

In the second step ST200, the torque value calculated in the TCB control step ST220 is applied to the maximum value (Max) and calculated, a minimum value (Min) is selected from calculated result values, and AWD control torque (Tqt) is calculated by calculating the minimum value (Min) and a handling torque value, which is outputted in the handling control step ST230, together.

In the TCB control step ST220, the minimum value (Min) is Selected, as described above, in consideration of accuracy and safety based on the torque value set based on the traveling mode. For example, in case that an intermediate value is selected, the range becomes wider, and an accurate torque value cannot be calculated. As a result, control torque accurately required for the two-speed AWD vehicle cannot be calculated.

Therefore, in the present embodiment, the minimum value (Min), together with the handling torque value, is transmitted to a controller 100 provided separately, and the controller 100 outputs optimal AWD control torque.

For reference, the second step ST200 is based on the traveling mode. For example, the second step ST200 refers to any one mode selected from an eco mode, a normal mode, or a sports mode.

Further, the gain value (α) and the minimum torque value (β) are based on the mode of the two-speed AND vehicle. For example, the mode may be any one mode selected from the 2H, 4A, 4H, and 4L modes.

The TCB control step ST220 is determined based on the traveling mode of the two-speed AND vehicle, longitudinal acceleration information, lateral acceleration information, wheel speed information, and a vehicle speed.

The vehicle speed condition is based on a case in which the vehicle speed is higher than a reference speed of the vehicle speed designated for each traveling mode. However, in the sports mode, esc-off is applied in a case in which a wheel slip exceeds a threshold value.

In addition, in the TCB control step ST220, a determination criterion is applied only in case that all of the traveling states of the two-speed AWD vehicle are satisfied. For example, the case in which the traveling state is satisfied refers to a case in which a steering angle is smaller than a reference angle, a case in which a steering angular velocity is lower than a reference angular velocity, a case in which a yaw rate is lower than a reference rate, and a case in which a lateral acceleration value is smaller than a reference acceleration value.

The traction control step ST210 according to the present embodiment further includes a basic anticipative torque control step ST211 of correcting a load distribution ratio by imparting a weight value to ensure performance according to the shift position and the traveling mode, a rolling prevention torque control step ST212 of classifying levels in accordance with an uphill traveling state and an inclination angle of a slope road when the two-speed AWD vehicle travels uphill or downhill, a start assistance torque control step ST213 of preventing a wheel slip when the two-speed AWD vehicle starts, and a low-shift-position shifting torque control step ST214 of performing control to output low-shift-position shifting torque for each gear shift position when the two-speed AWD vehicle shifts to a low shift position.

In the basic anticipative torque control step ST211, a basic anticipative torque value is calculated in consideration of the corrected load distribution ratio for the torque transmitted to the two-speed AWD vehicle.

The rolling prevention torque control step ST212 is applied to ensure stable traction performance when the two-speed AWD vehicle travels uphill or downhill. In addition, the uphill traveling state is determined by using a longitudinal acceleration, a lateral acceleration, a wheel speed, a steering angle, an accelerator opening degree, and braking pressure information occurring when the two-speed AWD vehicle travels.

For example, the levels are classified in accordance with the uphill traveling state of the two-speed AWD vehicle, and a designated rolling prevention torque value according to the traveling mode is outputted.

In the start assistance torque control step ST213, a vehicle speed criterion and a torque control value are differently set in accordance with the traveling mode of the two-speed AWD vehicle. For example, a torque control amount for each gear shift position is classified in accordance with the accelerator opening degree of the two-speed AWD vehicle, and a start assistance torque output is based on a speed of the two-speed AND vehicle.

The low-shift-position shifting torque control step ST214 is applied to stabilize a vehicle motion due to engine braking when the two-speed AWD vehicle shifts to the low shift position while the two-speed AWD vehicle travels.

For example, an entry time point is controlled in a non-braking or non-acceleration state in which a target gear shift position is lower than a current gear shift position.

In the handling control step ST230, turning torque is calculated in accordance with a turning weight value according to a lateral acceleration, a yaw rate, and a steering angle according to turning characteristics of the two-speed AWD vehicle.

The traveling modes according to the turning characteristics may be a neutral steer (NS) mode, an under steer (US) mode, an over steer (OS) mode, and a counter steer (CS) mode.

The NS mode refers to a situation in which an actual turning radius is equal to a target turning radius of a driver, and the US mode refers to a situation in which an actual turning radius is smaller than the target turning radius of the driver.

Further, the OS mode refers to a situation in which an actual turning radius is larger than the target turning radius of the driver, and the CS mode refers to a traveling mode in which a rotation direction of a steering angle in the OS mode state is changed instantaneously.

In the present embodiment, a turning weight value is determined based on the lateral acceleration, the yaw rate, and the steering angle for each of the US mode, the OS mode, the NS mode, and the CS mode. In addition, the turning torque is calculated at ordinary times in consideration of the turning weight value for the torque transmitted to the two-speed AWD vehicle. The torque may be applied to prevent the occurrence of motion instability caused by a slip as a result of a sudden transition to 2WD even in a situation in which the accelerator opening degree is 0.

In this case, both stability and accuracy corresponding to traveling in the 4H or 4L mode of the two-speed AWD vehicle may be stabilized.

The 4H or 4L mode of the two-speed AWD vehicle is classified into a P-shift position stop mode in which the two-speed AWD vehicle switches to 2WD in a P-shift position stop state, a D/R/N-shift position stop mode for controlling traveling of the driver when the two-speed AWD vehicle is in a D-shift position state, an R-shift position state, or an N-shift position state, a gear shifting standby mode for restricting torque occurring when the two-speed AWD vehicle suddenly shifts from the low shift position to the high shift position or from the high shift position to the low shift position, a low-speed optimized traveling mode in which a minimum torque value is outputted to the propeller shaft in the 4A mode of the two-speed AWD vehicle, and a high-speed optimized traveling mode in which a maximum torque value is outputted to the propeller shaft in the 4A mode of the two-speed AWD vehicle.

In the related art, as described above, the maximum torque is outputted to the propeller shaft without detailed segmentalized 4H and 4L modes. However, in the present embodiment, all the 4H and 4L modes are segmentalized into five types of modes, thereby performing more optimized control in the 4H and 4L modes.

For example, in the P-shift position stop mode, the state switches to the 2WD state because predictive control of the traveling of the driver is unnecessary. In the D/R/N-shift position stop mode, standby mode control is performed to anticipatively control the traveling of the driver, and the torque control may be performed at 300 Nm, for example, in order to prepare for a start state caused by a sudden accelerator input by the driver.

The gear shifting standby mode is implemented as a torque control restriction mode for gear shifting control of a two-speed AWD system. Because the low-speed optimized traveling mode and the high-speed optimized traveling mode require relatively high torque during low-speed traveling in comparison with high-speed traveling, the section is divided based on a speed, and optimized traveling control is performed.

In addition, the torque amount required to directly connect the propeller shaft is actively controlled to transmit a front and rear wheel driving force ratio at 1:1.

For example, in the P-shift position stop mode, the D/R/N-shift position stop mode, and the gear shifting standby mode, a movement trajectory indicated by a bold solid line illustrated in the drawing is maintained in case that the vehicle speed is 0. Further, the high-speed optimized traveling mode is implemented after the vehicle speed increases to a high-speed reference speed in the low-speed optimized traveling mode.

Further, the vehicle speed converges to 0 after the low-speed optimized traveling mode, the high-speed optimized traveling mode, and the low-speed optimized traveling mode are implemented.

According to the embodiments of the present disclosure, it is possible to perform the optimal torque control required to directly connect the propeller shaft of the two-speed AWD vehicle, thereby improving the durability of the constituent components and reducing the power consumption.

According to the embodiments of the present disclosure, it is possible to further segmentalize the traveling state in the 4H or 4L mode of the two-speed AWD vehicle and perform the control in accordance with the segmentalization, thereby performing more accurate control under various conditions.

While the exemplary embodiments of the present disclosure have been described above, those skilled in the art may variously modify and change the present disclosure by adding, changing, deleting or modifying constituent elements without departing from the spirit of the present disclosure disclosed in the claims, and the modification and change also belong to the scope of the present disclosure.

### DESCRIPTION OF REFERENCE NUMERALS

100: Controller

What is claimed is:

1. A method of controlling a two-speed AWD vehicle, the method comprising:
a first step ST100 of selecting any one of a 4H mode or a 4L mode and allowing a two-speed AWD vehicle to travel; and
a second step ST200 of performing control to output AWD control torque, which is transmitted to a propeller shaft, as a minimum torque value in accordance with the mode selected from the 4H mode or the 4L mode.

2. The method of claim 1, wherein the second step ST200 further comprises:
a traction control step ST210 of calculating traction total torque to output a maximum value (Max) for torque control in accordance with various traveling situations of the two-speed AWD vehicle;
a TCB control step ST220 of controlling torque generated when the two-speed AWD vehicle is under a low-speed, high-steering traveling condition; and
a handling control step ST230 of calculating handling control torque based on a traveling mode corresponding to turning characteristics of the two-speed AWD vehicle.

3. The method of claim 2, wherein in the traction control step ST210, different gain values are applied based on shift positions of the two-speed AWD vehicle.

4. The method of claim 3, wherein in the traction control step ST210, a minimum torque value (β) is applied to the gain value of the two-speed AWD vehicle, and the maximum value (Max) is selected from calculated result torque values.

5. The method of claim 4, wherein in the second step ST200, the torque value calculated in the TCB control step ST220 is applied to the maximum value (Max) and calculated, a minimum value (Min) is selected from calculated result values, and AWD control torque is calculated by calculating the minimum value (Min) and a handling torque value, which is outputted in the handling control step ST230, together.

6. The method of claim 2, wherein the traction control step ST210 further comprises:
a basic anticipative torque control step ST211 of correcting a load distribution ratio by imparting a weight value to ensure performance according to the shift position and the traveling mode;
a rolling prevention torque control step ST212 of classifying levels in accordance with an uphill traveling state and an inclination angle of a slope road when the two-speed AWD vehicle travels uphill or downhill;
a start assistance torque control step ST213 of preventing a wheel slip when the two-speed AWD vehicle starts; and
a low-shift-position shifting torque control step ST214 of performing control to output low-shift-position shifting torque for each gear shift position when the two-speed AWD vehicle shifts to a low shift position.

7. The method of claim 6, wherein in the rolling prevention torque control step ST212, the uphill traveling state is determined by using a longitudinal acceleration, a lateral acceleration, a wheel speed, a steering angle, an accelerator opening degree, and braking pressure information.

8. The method of claim 6, wherein in the start assistance torque control step ST213, a vehicle speed criterion and a torque control value are differently set in accordance with the traveling mode of the two-speed AWD vehicle.

9. The method of claim 6, wherein in the start assistance torque control step ST213, a torque control amount for each gear shift position is classified in accordance with the accelerator opening degree of the two-speed AWD vehicle, and a start assistance torque output is based on a speed of the two-speed AWD vehicle.

10. The method of claim 6, wherein in the low-shift-position shifting torque control step ST214, an entry time point is controlled in a non-braking or non-acceleration state in which a target gear shift position is lower than a current gear shift position.

11. The method of claim 2, wherein the TCB control step ST220 is determined based on the traveling mode of the two-speed AWD vehicle, longitudinal acceleration and lateral acceleration information, wheel speed information, and a vehicle speed.

12. The method of claim 2, wherein in the handling control step ST230, turning torque is calculated in accordance with a turning weight value according to a lateral acceleration, a yaw rate, and a steering angle according to turning characteristics of the two-speed AWD vehicle.

13. The method of claim 1, wherein the 4H or 4L mode of the two-speed AWD vehicle is classified into:
a P-shift position stop mode in which the two-speed AWD vehicle switches to 2WD in a P-shift position stop state;
a D/R/N-shift position stop mode for controlling traveling of a driver when the two-speed AWD vehicle is in a D-shift position state, an R-shift position state, or an N-shift position state;
a gear shifting standby mode for restricting torque occurring when the two-speed AWD vehicle suddenly shifts from a low shift position to a high shift position or from the high shift position to the low shift position;
a low-speed optimized traveling mode in which a minimum torque value is outputted to the propeller shaft in a 4A mode of the two-speed AWD vehicle; and
a high-speed optimized traveling mode in which a maximum torque value is outputted to the propeller shaft in the 4A mode of the two-speed AWD vehicle.
